(19) United States
(12) Patent Application Publication
(10) Pub. No.: US 2019/0255620 A1
(43) Pub. Date: Aug. 22, 2019

(54) PRINTING SYSTEM AND METHOD OF USE

(71) Applicant: Fredric James French, Arlington, TX (US)

(72) Inventor: Fredric James French, Arlington, TX (US)

(21) Appl. No.: 16/277,448

(22) Filed: Feb. 15, 2019

Related U.S. Application Data
(60) Provisional application No. 62/632,901, filed on Feb. 20, 2018.

(51) Int. Cl. B22F 7/00

(52) U.S. Cl. CPC B22F 7/008; B33Y 10/00

(57) ABSTRACT

A printing method includes programming a 3D printer to print a three-dimensional product, the three-dimensional product being one of a coin, a round, or a bar; selecting a precious metal from one of gold, silver, and copper; providing the 3D printer with the precious metal; directing the 3D printer to create the three-dimensional product with the precious metal; and applying a layer of graphene to a surface of the three-dimensional product; the layer of graphene provides protection to the three-dimensional product.

### BACKGROUND

### 1. Field of the Invention

The present invention relates generally to systems and method for making coins and the like, and more specifically to a system and method for printing coins, rounds, bars, and other shapes with precious metal through a 3D printer.

### 2. Description of Related Art

Making coins (and other three-dimensional money products) is well known in the art. FIG. 1 depicts a flowchart 101 of a conventional method of making a coin, the method comprising running a strip of metal through a blanking press to punch out round discs to create blanks, as shown with box 103. The blanks are then run through an upsetting mill to raise a rim of the edges of the blanks, as shown with box 105. Next, the blanks are stamped with the desired design with a coining press, as shown with box 107.

One of the problems commonly associated with method 101 is inefficiency. For example, it is common for the method to result in coins that are misshapen, stamped unevenly, or the like, thereby making the coins unusable.

Accordingly, although great strides have been made in the area of coin and money product making systems and methods, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a flowchart of a common method of making a coin;

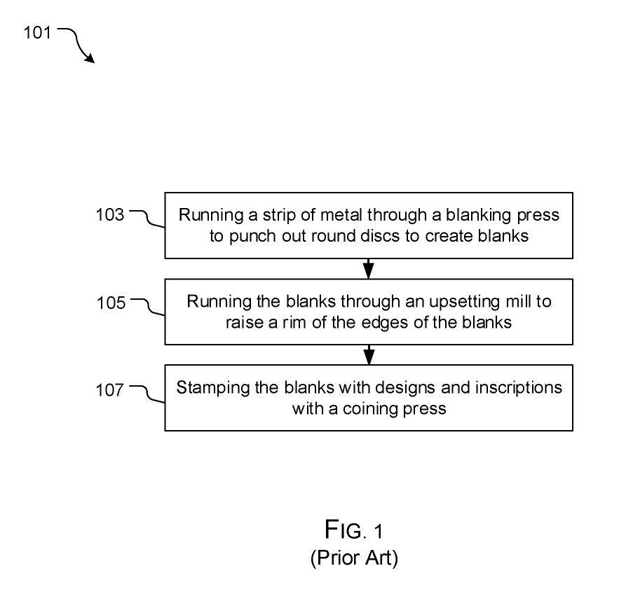

FIG. 2 is a simplified schematic of a printing system in accordance with a preferred embodiment of the present application; and

FIG. 3 is a flowchart of the method associated with the system of FIG. 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional money product making systems. Specifically, the present invention provides for a system and method for accurately making coins (and other money products) that are superior in quality and consistency when compared to conventional methods. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

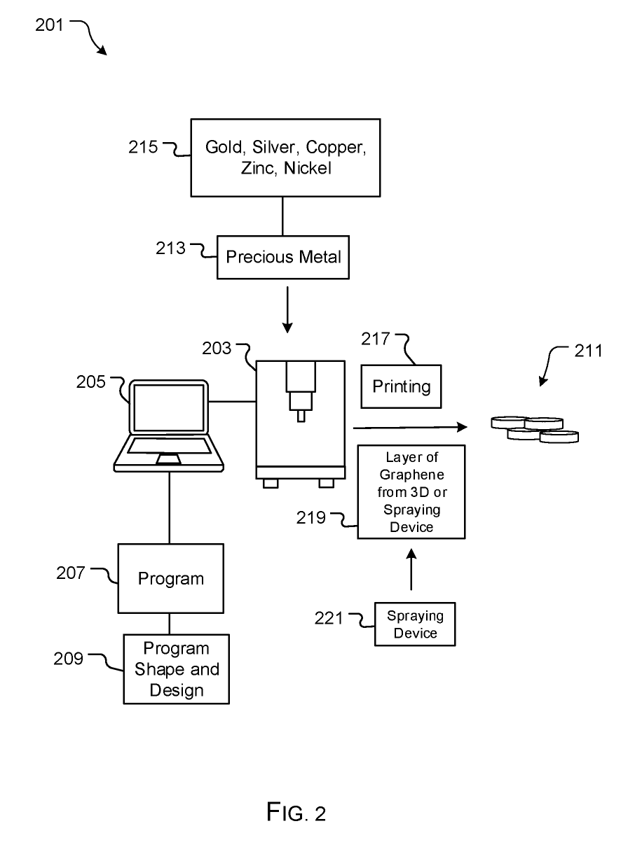

Referring now to the drawings wherein like reference characters identify corresponding or similar elements throughout the several views, FIG. 2 depicts a simplified schematic of a three-dimensional product printing system 201 in accordance with a preferred embodiment of the present application. It will be appreciated that system 201 overcomes one or more of the above-listed problems commonly associated with conventional money-product making systems. It should be appreciated that the system and method of the present application is applicable to all three-dimensional money products, such as coins, founds, bars, and other shape and is not limited to coins, as will be the primary focus of the present application.

In the contemplated embodiment, system 201 includes a 3D printer 203 associated with a computing device 205, wherein the computing device 205 includes a program 207 configured to receive commands from a user. It should be appreciated that the computing device 205 can be incorporated directly into the 3D printer, or alternatively, can be a stand alone unit. It should be appreciated that the program 207 provides for user input of three-dimensional shape and design 209 of a three-dimensional product 211 to be created.

System 201 further includes a precious metal 213, such as one of gold, silver, copper, zinc, and nickel 215 to be utilized by 3D printer 203. The user selects a metal and programs the 3D printer to print 217 the three-dimensional product 211, such as coins.

System 201 further includes the application of a layer of graphene 219 to the three-dimensional product 211. The layer of graphene 219 can be sprayed on via a spraying device 221, or alternatively could be added directly with the 3D printer. It should be appreciated that the graphene provides for a layer that is corrosion resistant, difficult to mar, and resistant to wear in ordinary use.

It should be appreciated that one of the unique features believed characteristic of the present application is the system and method for 3D printing products and adding a layer of graphene to the products, particularly money products. This system and method provide for coins and other products that are superior in quality and consistency when compared to conventional methods.

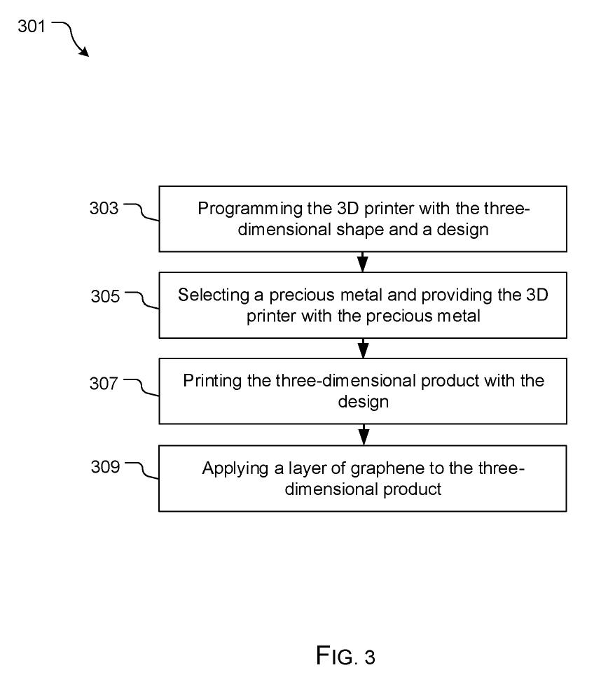

In FIG. 3, a flowchart 301 depicts a method of use of system 201. During use, the user programs the 3D printer with a three-dimensional shape and a design (such as the design of a coin), as shown with box 303. The user selects a precious metal and utilizes the 3D printer to print the three-dimensional product with the selected precious metal, as shown with boxes 305, 307. A layer of graphene is added to the three-dimensional product either though the 3D printer or a sprayer device, as shown with box 309.

It should be appreciated that although graphene is preferred, other similarly suited materials can be utilized in different embodiments in addition to different methods of applying said materials to the precious metals during and after formation.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A printing method, comprising:
programming a 3D printer to print a three-dimensional product, the three-dimensional product being one of a coin, a round, or a bar;
selecting a precious metal from one of gold, silver, copper, zinc, and nickel;
providing the 3D printer with the precious metal;
directing the 3D printer to create the three-dimensional product with the precious metal; and
applying a layer of graphene to a surface of the three-dimensional product;
wherein the layer of graphene provides protection to the three-dimensional product.

2. The method of claim 1, wherein the layer of graphene is applied with the 3D printer.

3. The method of claim 1, wherein the layer of graphene is sprayed onto the three-dimensional product.

4. The method of claim 1, wherein the programming of the 3D printer includes programming a design to be implemented on a surface of the three-dimensional product.

5. The method of claim 4, wherein the design is a coin design.
